(19) United States
(12) Patent Application Publication
(10) Pub. No.: US 2016/0012802 A1
(43) Pub. Date: Jan. 14, 2016

(54) METHOD OF OPERATING DISPLAY DRIVER INTEGRATED CIRCUIT AND METHOD OF OPERATING IMAGE PROCESSING SYSTEM HAVING THE SAME

(71) Applicant: SAMSUNG ELECTRONICS CO., LTD., Suwon-si (KR)

(72) Inventors: Soo Young WOO, Hwaseong-si (KR); Yang Hyo KIM, Suwon-si (KR); Do Kyung KIM, Yongin-si (KR)

(73) Assignee: SAMSUNG ELECTRONICS CO., LTD., Suwon-si (KR)

(21) Appl. No.: 14/730,344

(22) Filed: Jun. 4, 2015

(30) Foreign Application Priority Data
Jul. 14, 2014 (KR) 10-2014-0088289

(51) Int. Cl. G09G 5/395; G09G 5/399

(52) U.S. Cl. CPC G09G 5/395; G09G 5/399; G09G 2360/12; G09G 2310/0286

(57) ABSTRACT

A method of operating a display driver integrated circuit (IC) is provided. The method includes storing first line data in a first memory; and reading, at the same time from the first memory, a first pixel data set and a second pixel data set, which are not adjacent to each other among the first line data stored in the first memory.

### CROSS-REFERENCE TO RELATED APPLICATIONS

This application claims priority from Korean Patent Application No. 10-2014-0088289 filed on Jul. 14, 2014, the disclosure of which is hereby incorporated by reference in its entirety.

### BACKGROUND

1. Field

Methods consistent with exemplary embodiments relate to a display driver integrated circuit (IC), and more particularly, to a method of operating the display driver IC which can read line data stored in a frame memory or a line buffer from each of a plurality of read start points at the same time and a method of operating an image processing system having the same.

2. Description of Related Art

As smart phones become popular, there are growing demands for high-resolution displays included in the smart phones and demands to increase the size of the displays. As the resolution and size of a smart phone display increase, there also an increase in the amount of data to be sent to the display. The increase in the amount of data requires an increasing clock speed to clock the data into the display. However, due to physical limitations, there is a limit to how much the clock speed may be increased. One option to increase the amount of data to the display is to increase an amount of data sent to the display at one time. However, this option creates a disadvantage in that the size of the parts used to drive the display also increase, resulting in an increase of the smart phone size.

### SUMMARY

One or more exemplary embodiments provide a method of operating a display driver IC which can read line data stored in a frame memory or a line buffer from each of a plurality of read start points at the same time and a method of operating an image processing system having the same so as to prevent a height of the display driver IC from being increased.

Further, one or more exemplary embodiments provide a method of operating the display driver IC which can transfer respective data read at the same time from each of a plurality of read start points to each of two of a plurality of input ports of a shift register block, and a method of operating an image processing system having the same.

Further still, one or more exemplary embodiments provide a method of operating a display driver IC which can perform an image enhancement operation on respective data read at the same time from each of the plurality of read start points in a parallel manner, and transfer respective image-enhanced data to each of two of the plurality of input ports of a shift register block in a parallel manner, and a method of operating an image processing system having the same.

According to an aspect of an exemplary embodiment, there is provided a method of operating a display driver integrated circuit (IC), the method including storing a first line data in a first memory; and reading, at the same time, a first pixel data set and a second pixel data set, which are not adjacent to each other among the first line data stored in the first memory.

According to an aspect of another exemplary embodiment, there is provided a method of operating an image processing system including a display driver integrated circuit (IC) and a host, the method including storing, in a first memory by the display driver IC, first line data included in image data output from the host; and reading, at the same time from the first memory by the display driver IC, a first pixel data set and a second pixel data set, which are not adjacent to each other among the first line data stored in the first memory.

According to an aspect of another exemplary embodiment, there is provided a method of parallel processing data using a display driver integrated circuit (IC), the method including reading in parallel a first set of pixel data and a second set of pixel data from line data having a first portion comprising a plurality of pixel data and a second portion comprising a plurality of pixel data, the pixel data of the first set being separated from the pixel data of the second set by pixel data for at least one pixel; performing an image enhancement operation in parallel on the first set and the second set to generate first enhanced pixel data and second enhanced pixel data respectively; and outputting in parallel the first enhanced pixel data and the second enhanced pixel data.

### BRIEF DESCRIPTION OF THE DRAWINGS

The above and/or other aspects will become apparent and more readily appreciated from the following description of exemplary embodiments, taken in conjunction with the accompanying drawings of which:

FIG. 1 is a block diagram of an image processing system according to an exemplary embodiment;

FIG. 2 is a schematic block diagram of a display driver IC of the image processing system shown in FIG. 1, according to an exemplary embodiment;

FIG. 3 is a block diagram which shows a control logic circuit of the display driver IC shown in FIG. 2, according to an exemplary embodiment;

FIG. 4 is an example of line data stored in a frame memory of the control logic circuit shown in FIG. 3;

FIG. 5 is a conceptual diagram which describes a simultaneous read according to an exemplary embodiment;

FIG. 6 is a conceptual diagram which describes a simultaneous read according to another exemplary embodiment;

FIG. 7 is a conceptual diagram which describes a simultaneous read according to still another exemplary embodiment;

FIG. 8 is a conceptual diagram which describes a simultaneous read according to still another exemplary embodiment;

FIG. 9 is a timing diagram of signals which describes an operation of the control logic circuit shown in FIG. 3, according to an exemplary embodiment;

FIG. 10 is a timing diagram of signals which describes an operation of the control logic circuit shown in FIG. 3, according to another exemplary embodiment;

FIG. 11 is a block diagram which shows a control logic circuit of the display driver IC shown in FIG. 2, according to another exemplary embodiment;

FIG. 12 is a timing diagram of signals which describes an operation of the control logic circuit shown in FIG. 11;

FIG. 13 is a block diagram which shows a control logic circuit of the display driver IC shown in FIG. 2, according to still another exemplary embodiment;

FIG. 14 is a timing diagram of signals which describes an operation of the control logic circuit shown in FIG. 13;

FIG. 15 is a flowchart which describes an operation of the display driver IC shown in FIG. 2, according to an exemplary embodiment; and

FIG. 16 is a flowchart which describes an operation of the display driver IC shown in FIG. 2, according to another exemplary embodiment.

### DETAILED DESCRIPTION OF EXEMPLARY EMBODIMENTS

The present inventive concepts now will be described more fully hereinafter with reference to the accompanying drawings, in which exemplary embodiments are shown. This present inventive concepts may, however, be embodied in many different forms and should not be construed as limited to the exemplary embodiments set forth herein. Rather, these exemplary embodiments are provided so that this disclosure will be thorough and complete, and will fully convey the scope of the present inventive concepts to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms “first”, “second”, etc. may be used herein to describe various elements, these elements should not be limited by these terms. These terms are only used to distinguish one element from another. For example, a “first” signal could be termed a “second” signal, and, similarly, a “second” signal could be termed a “first” signal without departing from the teachings of the disclosure.

The terminology used herein is for the purpose of describing particular exemplary embodiments only and is not intended to be limiting of the present inventive concepts. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the present inventive concepts belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

An image processing system such as a smart phone includes a display driver IC which can drive a display. The display driver IC includes a shift register which can store line data to be transferred to the display.

As a resolution of the display is increased, a frequency of a shift clock supplied to the shift register needs to be increased. However, due to physical limitations, e.g., an RC load, there is a limit to the amount that the frequency of the shift clock may be increased. The frequency of the shift clock is closely related to a resolution of the display and the number of bits of data shifted at one time. That is, the frequency of the shift clock is increased as the resolution of the display is increased, and the frequency of the shift clock decreases as the number of bits of data shifted at one time is increased.

In order to prevent a frequency of the shift clock from increasing as the resolution of the display is increased, the number of bits of data shifted at one time may be increased. However, when the number of bits of data shifted at one time in a shift register is increased, there is a disadvantage in that a height of the display driver IC including the shift register is also increased.

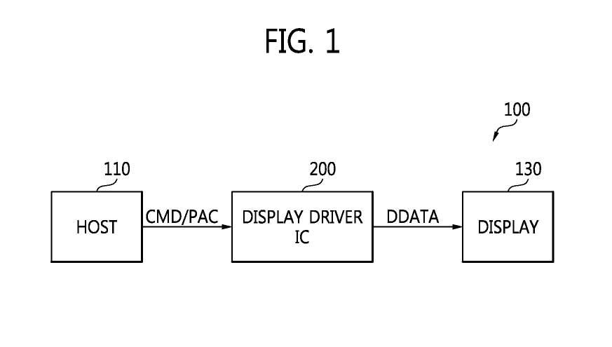

FIG. 1 is a block diagram of an image processing system according to an exemplary embodiment. Referring to FIG. 1, an image processing system 100 includes a host 110, a display driver IC 200, and a display 130.

The image processing system 100 may be embodied as a portable electronic device. The portable electronic device may be embodied as a laptop computer, a mobile phone, a smart phone, a tablet PC, a personal digital assistant (PDA), an enterprise digital assistant (EDA), a digital still camera, a digital video camera, a portable multimedia player (PMP), a personal navigation device or portable navigation device (PND), a handheld game console, a mobile internet device (MID), a wearable computer, an internet of things (IoT) device, an internet of everything (IoE) device, or an e-book, or the like.

The host 110 may be embodied as an integrated circuit (IC), a system on chip (SoC), an application processor (AP), or a mobile AP, or the like. The host 110 may control an operation of the display driver IC 200. The host 110 may transfer a data packet PAC to the display driver IC 200 through an interface. For example, the data packet PAC may include synchronization signals and image data. Here, the synchronization signals may include a vertical synchronization signal, a horizontal synchronization signal, and a data enable signal.

For example, the host 110 may transfer a clock signal to the display drive IC 200 through an interface. In some exemplary embodiments, the clock signal may be transferred through a second line which is different from a first line for transferring the data packet PAC. Alternatively, the clock signal may be embedded in the data packet PAC to be transferred.

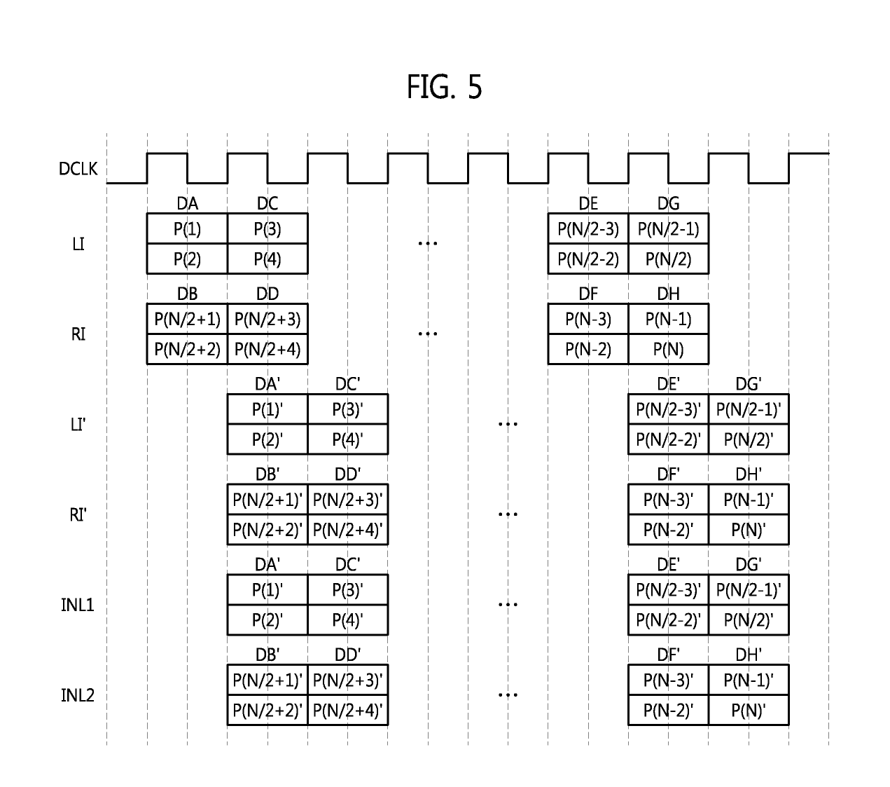

The host 110 may transfer a command CMD to the display driver IC 200 through an interface. An operation of a control logic circuit related to a command CMD will be described in detail with reference to FIGS. 5 to 8.

For example, the interface may be embodied in an MIPI® or an embedded Display Port (eDP). For example, the interface may be embodied as an MIPI® display serial interface (DSI).

The display driver IC 200 may process image data included in the data packet PAC, and transfer display data DDATA generated according to a result of the processing to the display 130. The display driver IC 200 may be embodied as a mobile display driver IC. The display 130 may be embodied as a flat panel display.

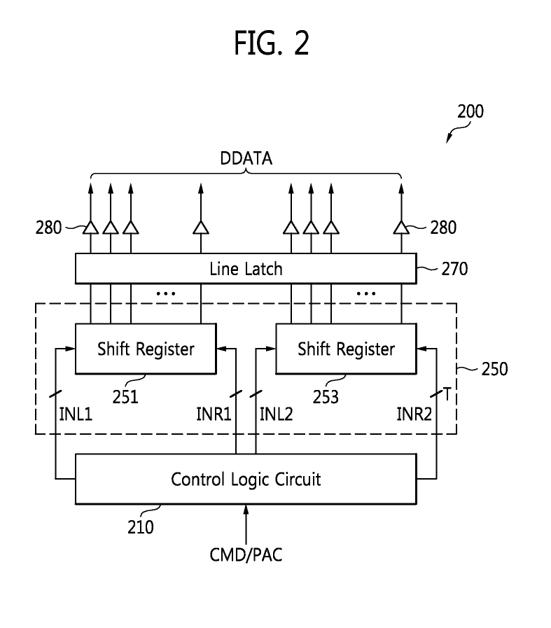

FIG. 2 is a schematic block diagram of the display driver IC shown in FIG. 1, according to an exemplary embodiment. Referring to FIGS. 1 and 2, the display driver IC 200 may include a control logic circuit 210, a shift register block 250, a line latch 270, and a plurality of drivers 280.

The control logic circuit 210 may control an operation of a shift register block 250. For example, the control logic circuit 210 may output group signals including first group signals INL1, second group signals INR1, third group signals INL2, and fourth group signals INR2 to the shift register block 250 in a parallel manner. The control logic circuit 210 may select two groups based on a command CMD.

The shift register block 250 may store data on a line basis. The shift register block 250 may include M shift registers, where M is a natural number. For convenience of description in FIG. 2, two shift registers 251 and 253 are shown to be described; however, a technical concept is not limited by the number of the shift registers included in the shift register block 250.

A line latch 270 may output line data output from the shift register block 250 to a plurality of drivers 280. In some exemplary embodiments, the line latch 270 may output the line data output from the shift register block 250 to the plurality of drivers 280 in response to a transfer control signal. In some exemplary embodiments, the transfer control signal may be output from the control logic circuit 210.

The plurality of drivers 280 may generate a plurality of analog signals using the line data, and output the plurality of analog signals to a plurality of data lines (or source lines) embodied in a panel of the display 130. Each of the plurality of drivers 280 may be embodied as an amplifier.

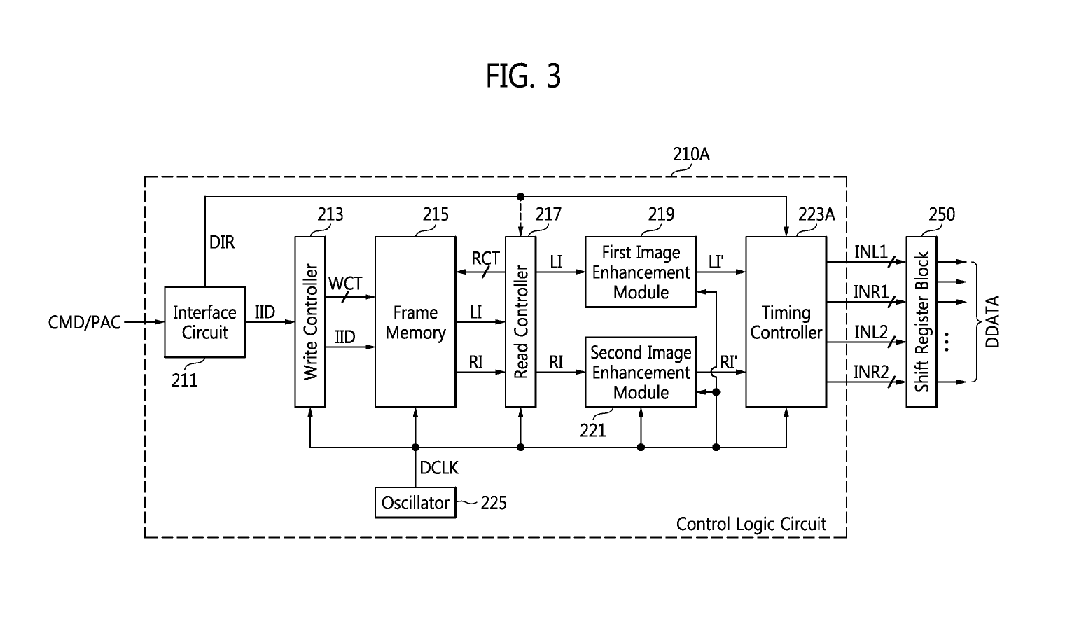

FIG. 3 is a block diagram which shows an exemplary embodiment of a control logic circuit shown in FIG. 2. Referring to FIGS. 1 to 3, a control logic circuit 210A may include an interface circuit 211, a write controller 213, a frame memory 215, a read controller 217, a plurality of image enhancement modules 219 and 221, a timing controller 223A, and an oscillator 225.

The interface circuit 211 may receive the data packet PAC output from the host 110, and restore (or generate) synchronization signals and image data IID from the data packet PAC using a clock signal. As described above, the clock signal may be provided separately from the data packet PAC to be transferred from the host 110, or be embedded in the data packet PAC.

In addition, the interface circuit 211 may receive and decode a command CMD output from the host 110, and generate a direction indication signal DIR according to a result of the decoding. In some exemplary embodiments, the direction indication signal DIR may be transferred to the read controller 217 or the timing controller 223A.

In some exemplary embodiments, a decoder which can generate the direction indication signal DIR may be embodied inside or outside the interface circuit 211.

The interface circuit 211 may transfer synchronization signals and image data IID to the write controller 213.

The write controller 213 may generate write control signals WCT using the display clock signal DCLK and synchronization signals, and write image data IID in the frame memory 215 using write control signals WCT. Accordingly the frame memory 215 may store the image data IID based on the display clock signal DCLK and the write control signals WCT. For example, the frame memory 215 may be embodied as a frame buffer or a graphic random access memory (GRAM).

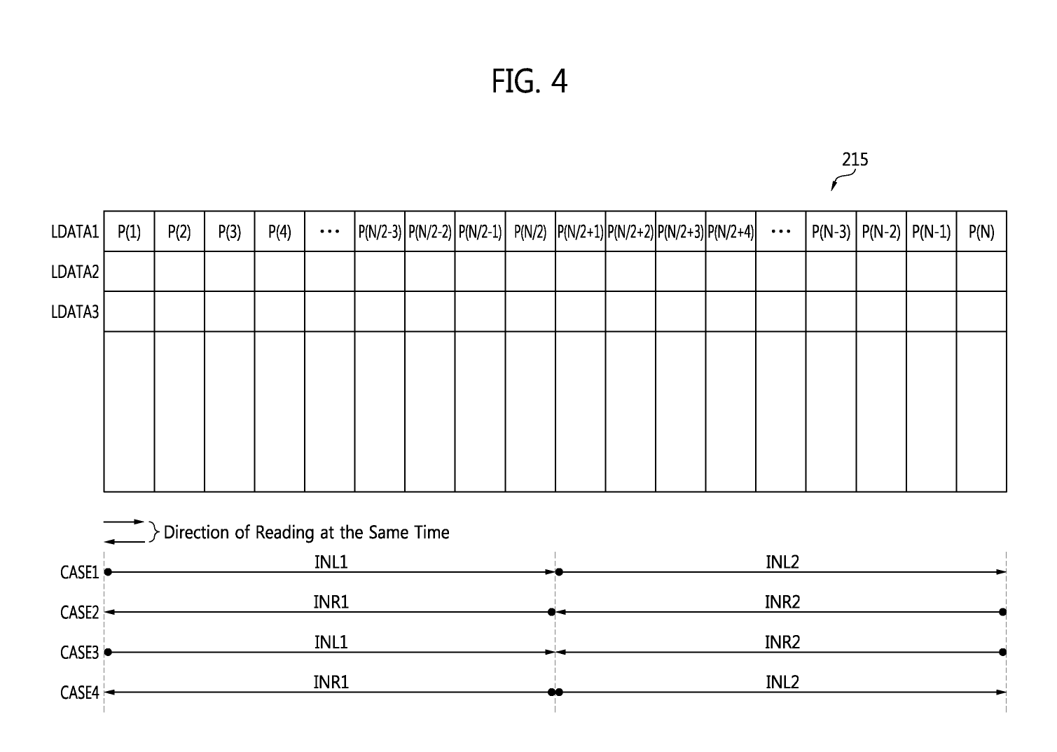

FIG. 4 is an example of line data stored in the frame memory shown in FIG. 3. As shown in FIG. 4, respective line data LDATA1, LDATA2, and LDATA3 may be stored in each line.

A first line data LDATA1 may include N pixel data P(1) to P(N), where N is a natural number. For example, each pixel data P(1) to P(N) may comprise 24-bits. Each pixel data P(1) to P(N) may include RGB data. Each pixel data P(1) to P(N/2) are stored in a first region of a first line, and each pixel data P(N/2+1) to P(N) are stored in a second region of the first line. That is, the pixel data P(1) to P(N/2) may be stored in a first portion of the first line, and the pixel data P(N/2+1) to P(N) may be stored in a second portion of the first line.

Referring to FIG. 3, a direction of a simultaneous read (or a simultaneous read operation) may be determined according to the direction indication signal DIR generated based on a command CMD. In some exemplary embodiments, the read controller 217 may generate read control signals RCT using the display clock DCLK output from the oscillator 225. In other exemplary embodiments, the read controller 217 may generate the read control signals RCT using the direction indication signal DIR and the display clock DCLK. Here, the read control signals RCT may denote signals which are used to read respective pixel data P(1) to P(N) stored in the frame memory 215.

Pixel data sets to be read at the same time from the frame memory 215 may be selected in response to the read control signals RCT. According to exemplary embodiments, each pixel data set may include one pixel data (for example, 24-bits), two pixel data (for example, 48-bits), four pixel data (for example, 96-bits), eight pixel data (for example, 192-bits), or sixteen pixel data (for example, 384-bits). For convenience of description in the present specification, it is assumed that each pixel data set includes two pixel data; however, the technical concept is not limited by the number of bits of pixel data included in each pixel data set.

A first image enhancement module 219 performs an image enhancement operation on a left pixel data set LI output on a pixel data set basis in response to the display clock DCLK, and outputs an image-enhanced left pixel data set LI′ to the timing controller 223A.

A second image enhancement module 221 performs an image enhancement operation on a right pixel data set RI output on a pixel data set basis in response to the display clock DCLK, and outputs an image-enhanced right pixel data set RI′ to the timing controller 223A. For example, the image-enhanced left pixel data set LI′ is a data set related to the left pixel data set LI, and the image-enhanced right pixel data set RI′ is a data set related to the right pixel data set RI.

The image enhancement operation may include a contrast enhancement, an edge enhancement, a sharpness enhancement, and/or a color saturation enhancement, or the like. In addition, each of the first image enhancement module 219 and the second image enhancement module 221 may be embodied as hardware which can perform a content adaptive backlight control (CABC) function.

The timing controller 223A may output group signals including a first group signals INL1, a second group signals INR1, a third group signals INL2, and a fourth group signals INR2 to the shift register block 250. The timing controller 22A selects two group signals of the first group signals INL1, the second group signals INR1, the third group signals INL2, and the fourth group signals INR2 to output in parallel to the shift register block based on the direction indication signal DIR. The oscillator 225 may generate the display clock DCLK which is used for an operation of the write controller 213, the frame memory 215, the read controller 217, the first image enhancement module 219 and the second image enhancement module 221, and the timing controller 223A.

FIG. 5 is a conceptual diagram which describes a simultaneous read according to an exemplary embodiment.

When the direction indication signal DIR has a first value, the timing controller 223A outputs the first group signals INL1 to left (or first) input terminals of the first shift register 251 (see FIG. 2), and outputs the third group signals INL2 to left (or third) input terminals of the second shift register 252 so as to perform a case 1 CASE1 (see FIG. 4). At this time, the first group signals INL1 and the third group signals INL2 are output to the shift register block 250 in parallel. The input terminals may each be referred to an input port.

In the case 1 CASE1, operations of the frame memory 215, the read controller 217, and the first image enhancement module 219 and the second image enhancement module 221 will be described referring to FIGS. 2, 4, and 5.

The read controller 217 may generate read control signals RCT based on the direction indication signal DIR. At a first rising edge of the display clock DCLK, the read controller 217 reads a left pixel data set LI=DA and a right pixel data set RI=DB from the frame memory 215 at the same time. That is, the frame memory 215 transfers both the left pixel data set LI=DA and the right pixel data set RI=DB to the read controller 217 at the same time in response to the display clock DCLK and the read control signals RCT. Here, the left pixel data set LI=DA includes two pixel data P(1) and P(2), and the right pixel data set RI=DB includes two pixel data P(N/2+1) and P(N/2+2).

At this time, each of a region of the frame memory 215 in which pixel data P(1) is stored and a region of the frame memory 215 in which pixel data P(N/2+1) is stored may denote a read start point.

The first image enhancement module 219 and the second image enhancement module 221 perform respective image enhancement operations on the left pixel data set LI=DA and the right pixel data set RI=DB, respectively, which are transferred in a parallel manner from the read controller 217, and output an image-enhanced left pixel data set LI′=DA′ and an image-enhanced right pixel data set RI′=DB′ to the timing controller 223A.

The timing controller 223A outputs an image-enhanced left pixel data set LI′=DA′ to the left input terminals of the first shift register 251, and outputs an image-enhanced right pixel data set RI′=DB′ to the left input terminals of the second shift register 252. A portion of the first group signals INL1 and a portion of the third group signals INL2 are output to the shift register block 250 in a parallel manner.

At a second rising edge of the display clock DCLK, the read controller 217 may read a left pixel data set LI=DC and a right pixel data set RI=DD from the frame memory 215 at the same time. Here, the left pixel data set LI=DC includes two pixel data P(3) and P(4), and the right pixel data set RI=DD includes two pixel data P(N/2+3) and P(N/2+4).

The first image enhancement module 219 and the second image enhancement module 221 perform respective image enhancement operations on the left pixel data set LI=DC and the right pixel data set RI=DD, respectively, which are transferred in a parallel manner from the read controller 217, and output an image-enhanced left pixel data set LI′=DC′ and an image-enhanced right pixel data set RI′=DD′, respectively, to the timing controller 223A.

The timing controller 223A outputs the image-enhanced left pixel data set LI′=DC′ to the left input terminals of the first shift register 251, and outputs the image-enhanced right pixel data set RI′=DD′ to the left input terminals of the second shift register 252. A portion of first group signals INL1 and a portion of the third group signals INL2 are output to the shift register block 250 in a parallel manner. The read controller 217, the first image enhancement module 219, the second image enhancement module 221, and the timing controller 223A proceed to read, process, and output pixel data in a similar manner on subsequent rising edges of the display clock DCLK until the line data has been processed.

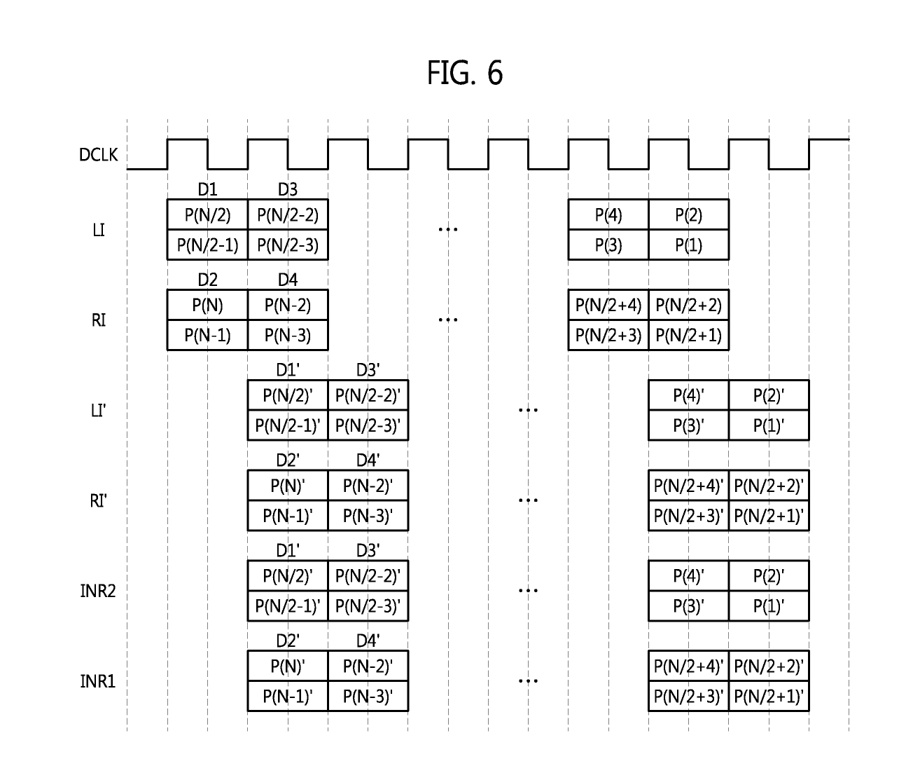

FIG. 6 is a conceptual diagram which describes a simultaneous read according to another exemplary embodiment.

When the direction indication signal DIR has a second value, the timing controller 223A outputs the second group signals INR1 to the right (or second) input terminals of the first shift register 251 and outputs the fourth group signals INR2 to the right (or fourth) input terminals of the second shift register 252 so as to perform a case 2 (CASE2). See FIG. 4. At this time, the second group signals INR1 and the fourth group signals INR2 are output to the shift register block 250 in a parallel manner.

In the case 2 CASE2, operations of the frame memory 215, the read controller 217, and the first image enhancement module 219 and the second image enhancement module 221 will be described referring to FIGS. 2, 4, and 6.

The read controller 217 may generate read control signals RCT based on the direction indication signal DIR. At the first rising edge of the display clock DCLK, the read controller 217 reads a left pixel data set LI=D1 and a right pixel data set RI=D2 from the frame memory 215 at the same time. Here, the left pixel data set LI=D1 includes two pixel data P(N/2) and P(N/2−1), and the right pixel data set RI=D2 includes two pixel data P(N) and P(N−1).

At this time, each of a region of the frame memory 215 in which pixel data P(N/2) is stored and a region of the frame memory 215 in which pixel data P(N) is stored may denote a read start point.

The first image enhancement module 219 and the second image enhancement module 221 perform respective image enhancement operations on the left pixel data set LI=D1 and the right pixel data set RI=D2, respectively, which are transferred in a parallel manner from the read controller 217, and output an image-enhanced left pixel data set LI′=D1′ and an image-enhanced right pixel data set RI′=D2′ to the timing controller 223A.

The timing controller 223A outputs the image-enhanced left pixel data set LI′=D1′ to the right input terminals of the first shift register 251, and outputs the image-enhanced right pixel data set RI′=D2′ to the right input terminals of the second shift register 252.

At the second rising edge of the display clock DCLK, the read controller 217 reads a left pixel data set LI=D3 and a right pixel data set RI=D4 from the frame memory 215 at the same time. Here, the left pixel data set LI=D3 includes two pixel data P(N/2−2) and P(N/2−3), and the right pixel data set RI=D4 includes two pixel data P(N−2) and P(N−3).

The first image enhancement module 219 and the second image enhancement module 221 perform respective image enhancement operations on the left pixel data set LI=D3 and the right pixel data set RI=D4, respectively, which are transferred in a parallel manner from the read controller 217, and outputs an image-enhanced left pixel data set LI′=D3′ and an image-enhanced right pixel data set RI′=D4′ to the timing controller 223A.

The timing controller 223A outputs an image-enhanced left pixel data set LI′=D3′ to the right input terminals of the first shift register 251, and outputs an image-enhanced right pixel data set RI′=D4′ to the right input terminals of the second shift register 252. The read controller 217, the first image enhancement module 219, the second image enhancement module 221, and the timing controller 223A proceed to read, process, and output pixel data in a similar manner on subsequent rising edges of the display clock DCLK until the line data has been processed.

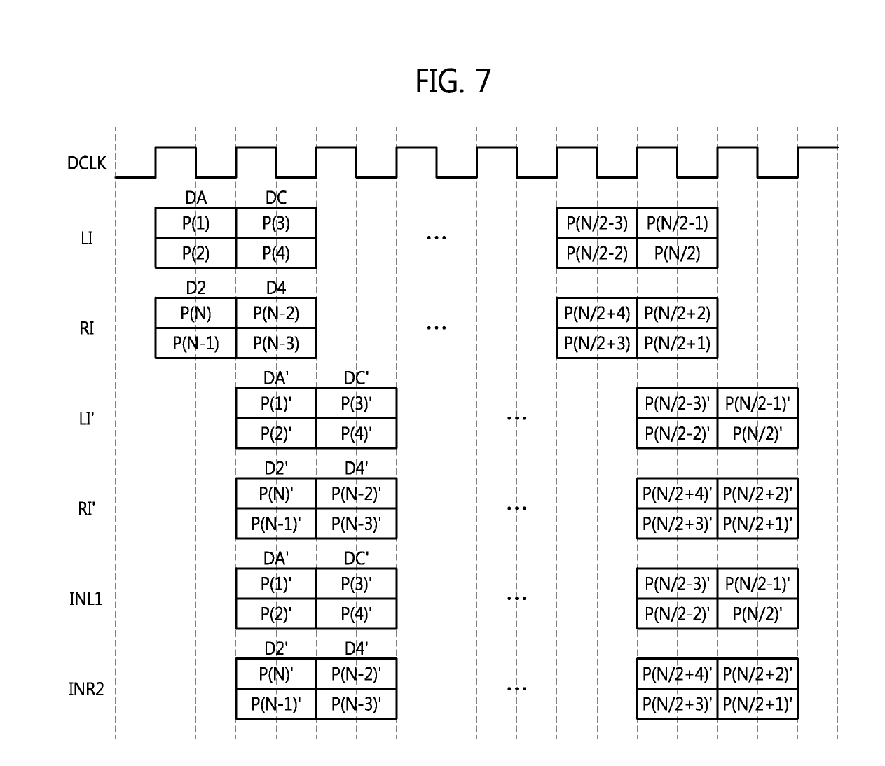

FIG. 7 is a conceptual diagram which describes a simultaneous read according to still another exemplary embodiment. When the direction indication signal DIR has a third value, the timing controller 223A outputs the first group signals INL1 to the left input terminal of the first shift register 251, and outputs the fourth group signals INR2 to the right input terminals of the second shift register 252 so as to perform a case 3 CASE3. The first group signals INL1 and the fourth group signals INR2 are output to the shift register block 250 in a parallel manner.

In the case 3 CASE3, operations of the frame memory 215, the read controller 217, and the first image enhancement module 219 and the second image enhancement module 221 will be described referring to FIGS. 2, 4, and 7. The read controller 217 may generate read control signals RCT based on the direction indication signal DIR. At the first rising edge of the display clock DCLK, the read controller 217 reads a left pixel data set LI=DA and a right pixel data set RI=D2 from the frame memory 215 at the same time.

Each of a region of the frame memory 215 in which a pixel data P(1) is stored and a region of the frame memory 215 in which a pixel data P(N) is stored may denote a read start point.

The first image enhancement module 219 and the second image enhancement module 221 perform respective image enhancement operations on the left pixel data set LI=DA and the right pixel data set RI=D2, respectively, which are transferred in a parallel manner from the read controller 217, and outputs an image-enhanced left pixel data set LI′=DA′ and an image-enhanced right pixel data set RI′=D2′ to the timing controller 223A.

The timing controller 223A outputs the image-enhanced left pixel data set LI′=DA′ to the left input terminals of the first shift register 251, and outputs the image-enhanced right pixel data set RI′=D2′ to the right input terminals of the second shift register 252.

At the second rising edge of the display clock DCLK, the read controller 217 reads a left pixel data set LI=DC and a right pixel data set RI=D4 from the frame memory 215 at the same time.

The first image enhancement module 219 and the second image enhancement module 221 perform respective image enhancement operations on the left pixel data set LI=DC and the right pixel data set RI=D4, respectively, which are transferred in a parallel manner from the read controller 217, and outputs an image-enhanced left pixel data set LI′=DC′ and an image-enhanced right pixel data set RI′=D4′ to the timing controller 223A.

The timing controller 223A outputs the image-enhanced left pixel data set LI′=DC′ to the left input terminals of the first shift register 251, and outputs the image-enhanced right pixel data set RI′=D4′ to the right input terminals of the second shift register 252. The read controller 217, the first image enhancement module 219, the second image enhancement module 221, and the timing controller 223A proceed to read, process, and output pixel data in a similar manner on subsequent rising edges of the display clock DCLK until the line data has been processed.

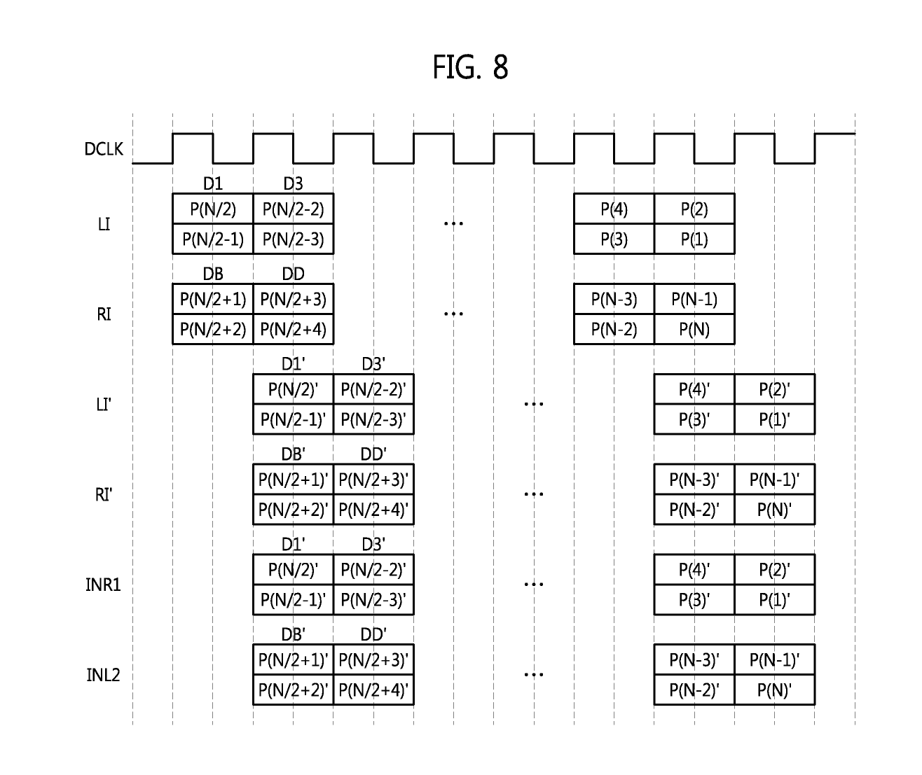

FIG. 8 is a conceptual diagram which describes a simultaneous read according to still another exemplary embodiment. When the direction indication signal DIR has a fourth value, the timing controller 223A outputs the second group signals INR1 to the right input terminals of the first shift register 251 and outputs the third group signals INL2 to the left input terminals of the second shift register 252 so as to perform a case 4 CASE4 (see FIG. 4). The second group signals INR1 and the third group signals INL2 are output to the shift register block 250 in a parallel manner.

In the case 4 CASE4, operations of the frame memory 215, the read controller 217, and the first image enhancement module 219 and the second image enhancement module 221 will be described referring to FIGS. 2, 4, and 8. The read controller 217 may generate read control signals RCT based on the direction indication signal DIR. At the first rising edge of the display clock DCLK, the read controller 217 reads a left pixel data set LI=D1 and a right pixel data set RI=DB from the frame memory 215 at the same time.

At this time, each of a region of the frame memory 215 in which a pixel data P(N/2) is stored and a region of the frame memory 215 in which a pixel data P(N/2+1) is stored may denote a read start point.

The first image enhancement module 219 and the second image enhancement module 221 perform respective image enhancement operations on the left pixel data set LI=D1 and the right pixel data set RI=DB, respectively, which are transferred in a parallel manner from the read controller 217, and output an image-enhanced left pixel data set LI′=D1′ and an image-enhanced right pixel data set RI′=DB′ to the timing controller 223A.

The timing controller 223A outputs the image-enhanced left pixel data set LI′=D1′ to the right input terminals of the first shift register 251, and outputs the image-enhanced right pixel data set RI′=DB′ to the left input terminals of the second shift register 252.

At the second rising edge of the display clock DCLK, the read controller 217 reads a left pixel data set LI=D3 and a right pixel data set RI=DD from the frame memory 215 at the same time.

The first image enhancement module 219 and the second image enhancement module 221 perform respective image enhancement operations on the left pixel data set LI=D3 and the right pixel data set RI=DD, respectively, which are transferred in a parallel manner from the read controller 217, and output an image-enhanced left pixel data set LI′=D3′ and an image-enhanced right pixel data set RI′=DD′ to the timing controller 223A.

The timing controller 223A outputs the image-enhanced left pixel data set LI′=D3′ to the right input terminals of the first shift register 251, and outputs the image-enhanced right pixel data set RI′=DD′ to the left input terminals of the second shift register 252. The read controller 217, the first image enhancement module 219, the second image enhancement module 221, and the timing controller 223A proceed to read, process, and output pixel data in a similar manner on subsequent rising edges of the display clock DCLK until the line data has been processed.

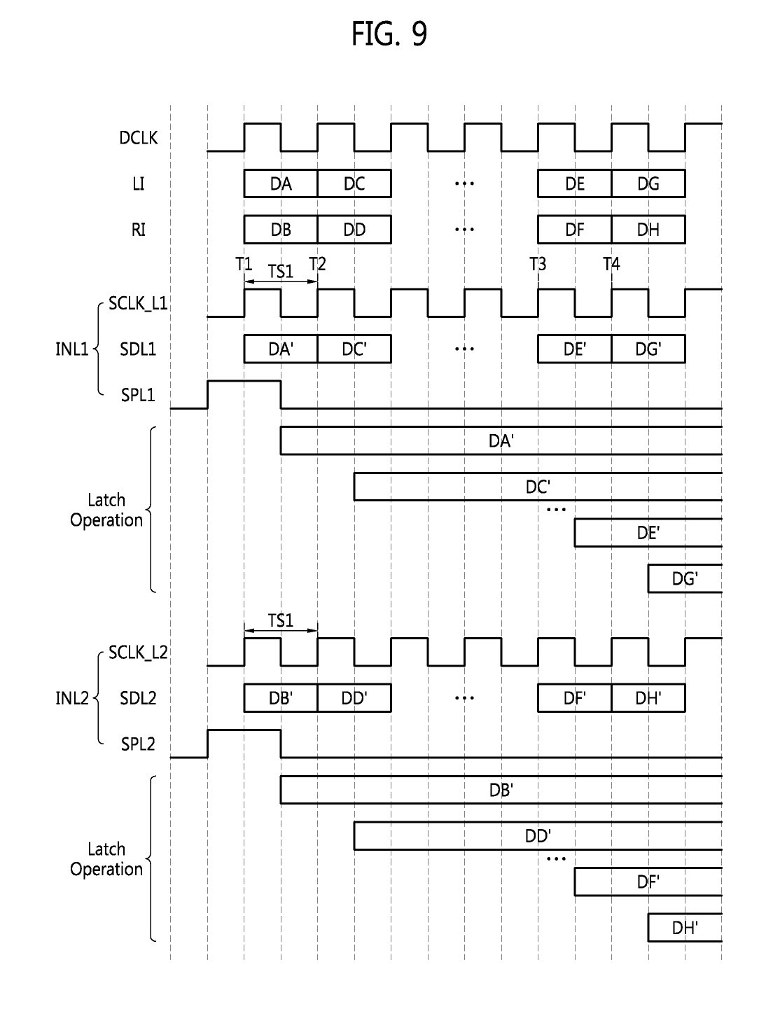

FIG. 9 is a timing diagram of signals of an operation of the control logic circuit shown in FIG. 3, according to an exemplary embodiment. Referring to FIGS. 1 to 5, and 9, the first group signals INL1 include a first shift clock SCLK_L1, a first input data SDL1, and a first shift start pulse SPL1.

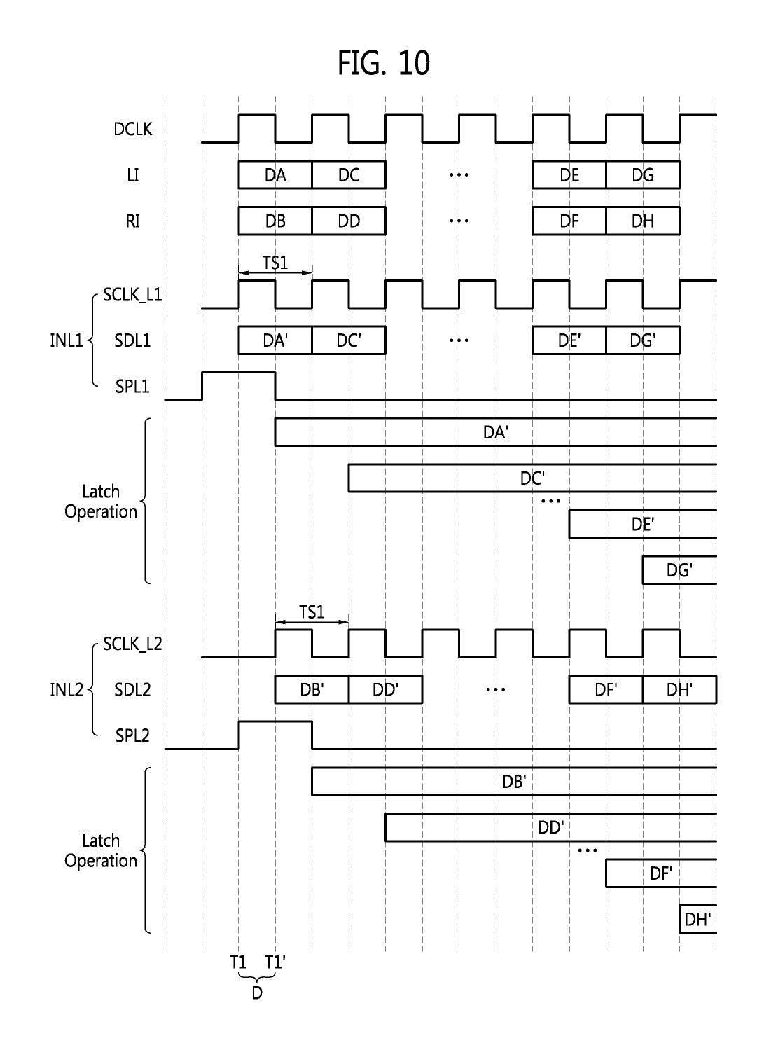

A cycle (or period) of the first shift clock SCLK_L1 may be equal to or different from a cycle (or period) of the display clock DCLK. For convenience of description in FIGS. 9 and 10, it is assumed that the cycle TS1 of the first shift clock SCLK_L1 is equal to the cycle of the display clock DCLK. The first shift register 251 may latch the first input data DA′, DC′, . . . , DE′, and DG′ at falling edges of the first shift clock SCLK_L1 after the first shift start pulse SPL1 is activated.

The third group signals INL2 include a second shift clock SCLK_L2, a second input data SDL2, and a second shift start pulse SPL2. For example, a frequency of the first shift clock SCLK_L1 may be equal to a frequency of a second shift clock SCLK=L2, and the first shift clock SCLK_L1 and the second shift clock SCLK_L2 may be synchronized with each other. In addition, the first shift start pulse SPL1 and the second shift start pulse SPL2 may be synchronized with each other.

The second shift register 253 may latch the second input data DB′, DD′, . . . , DF′, and DH′ at falling edges of the second shift clock SCLK_L2 after the second shift start pulse SPL2 is activated.

As shown in FIG. 9, corresponding pixel data sets DA and DB, DC and DD, . . . , DE and DF, and DG and DH are read from the frame memory 215 at the same time (or in a parallel manner) at each time point T1, T2, . . . , T3 and T4, and corresponding pixel data sets DA′ and DB′, DC′ and DD′, . . . , DE′ and DF′, and DG′ and DH′ processed at the same time (or in a parallel manner) by the first image enhancement module 219 and the second image enhancement module 221, respectively, may be transferred to input terminals of the shift register 251 and the shift register 253, respectively, at the same time (or in a parallel manner).

That is, the read controller 217 does not sequentially read first pixel data to last pixel data (or alternatively last pixel data to first pixel data) included in the line data stored in the frame memory 215, but reads corresponding pixel data sets DA and DB, DC and DD, . . . , DE and DF, and DG and DH at the same time.

FIG. 10 is a timing diagram of signals of an operation of the control logic circuit shown in FIG. 3, according to another exemplary embodiment.

As shown in FIG. 10, a given delay D is present between a time point when each of the first group signals INL1 is transferred to the first shift register 251 and a time point when each of the third group signals INL2 is transferred to the second shift register 253. That is, the given delay is a time between a rising time point T1 of the first shift clock SCLK_L1 and a rising time point T1′ of the second shift clock SCLK_L2.

As the given delay is present between a first time point when respective first input data DA′, DC′, . . . , DE′, and DG′ are latched while being shifted and a second time point when respective second input data DB′, DD′, . . . , DF′, and DH′ are latched while being shifted, a peak current consumed in the display driver IC 200 may be reduced, and an electromagnetic interference (EMI) may be reduced. The given delay D may be shorter than one cycle TS1. For example, the delay may be a half of one cycle TS1; however, the delay D is not limited to a half of one cycle TS 1 and may be changed.

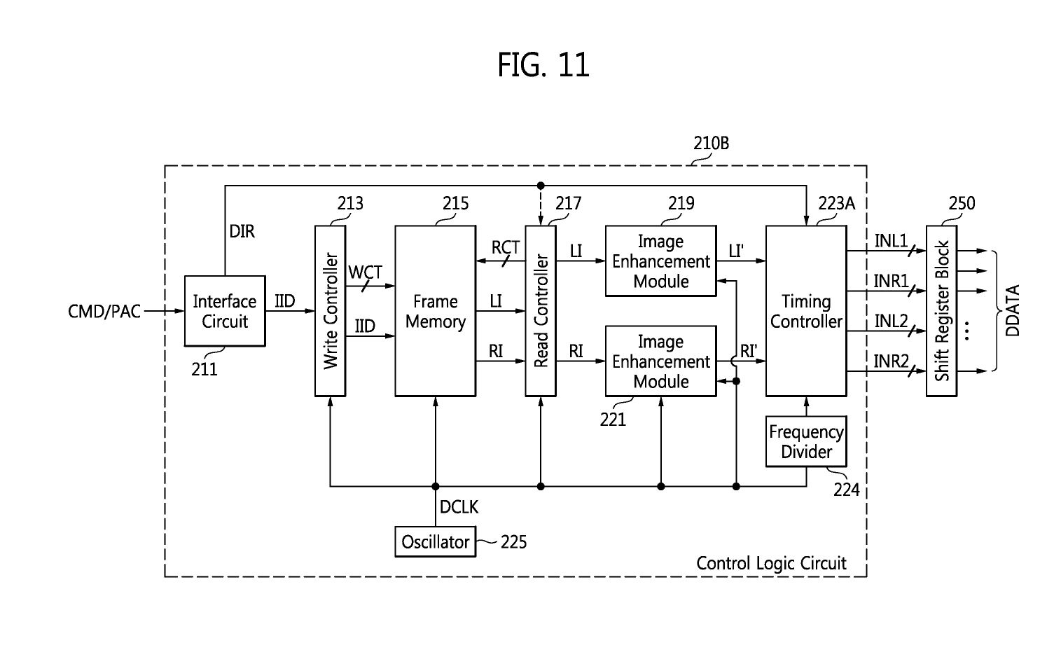

FIG. 11 is a block diagram which shows a control logic circuit of the display driver IC shown in FIG. 2, according to another exemplary embodiment.

Except for a frequency divider 224, a structure and an operation of the control logic circuit 210B shown in FIG. 11 are substantially the same as a structure and an operation of the control logic circuit 210A shown in FIG. 3.

The frequency divider 224 divides a frequency of the display clock DCLK according to a division ratio, and supplies an operation clock signal with a divided frequency to the timing controller 223A.

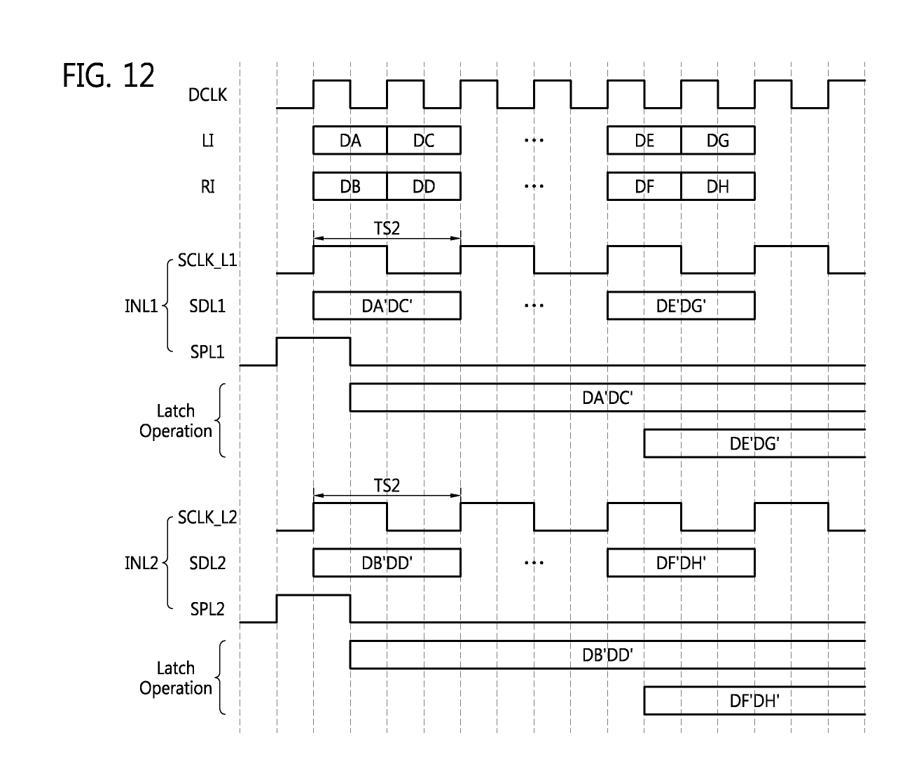

FIG. 12 is a timing diagram of signals which describes an operation of the control logic circuit shown in FIG. 11. For convenience of description, the operation of the control logic circuit 210B shown in FIG. 11 is described only for a case in which the control logic circuit 210B performs operations corresponding to the case 1 CASE1 of FIG. 4. However, the operations for the remaining cases 2 CASE2 to case 4 CASE 4 shown in FIG. 4 are similar. Referring to FIGS. 11 and 12, a division ratio of the frequency divider 224 is assumed to be 2. However, this is only an example and the division ratio may be more than 2, as described below.

Referring to FIGS. 9 and 12, a cycle TS2 of each shift clock SCLK_L1 and SCLK_L2 is twice as long as the cycle TS1 of each shift clock SCLK_L1 and SCLK_L2 shown in FIG. 9. That is, a frequency (or speed) of each shift clock SCLK_L1 and SCLK_L2 shown in FIG. 12 is a half of the frequency (or speed) of each shift clock SCLK_L1 and SCLK_L2 shown in FIG. 9. Moreover, a size of respective input data SDL1 and SDL2 shown in FIG. 12 is twice as large as a size of respective input data SDL1 and SDL2 shown in FIG. 9. That is, a shift data width is increased by two.

When a division ratio of the frequency divider 224 is set to be K, where K is a natural number greater than 2, the cycle (or period) of each shift clock SCLK_L1 and SCLK_L2 shown in FIG. 12 may be increased K times longer than the cycle (or period) of each shift clock SCLK_L1 and SCLK_L2 shown in FIG. 9, and the size of each input data SDL1 and SDL2 shown in FIG. 12 may be increased K times larger than the size of each input data SDL1 and SDL2 shown in FIG. 9.

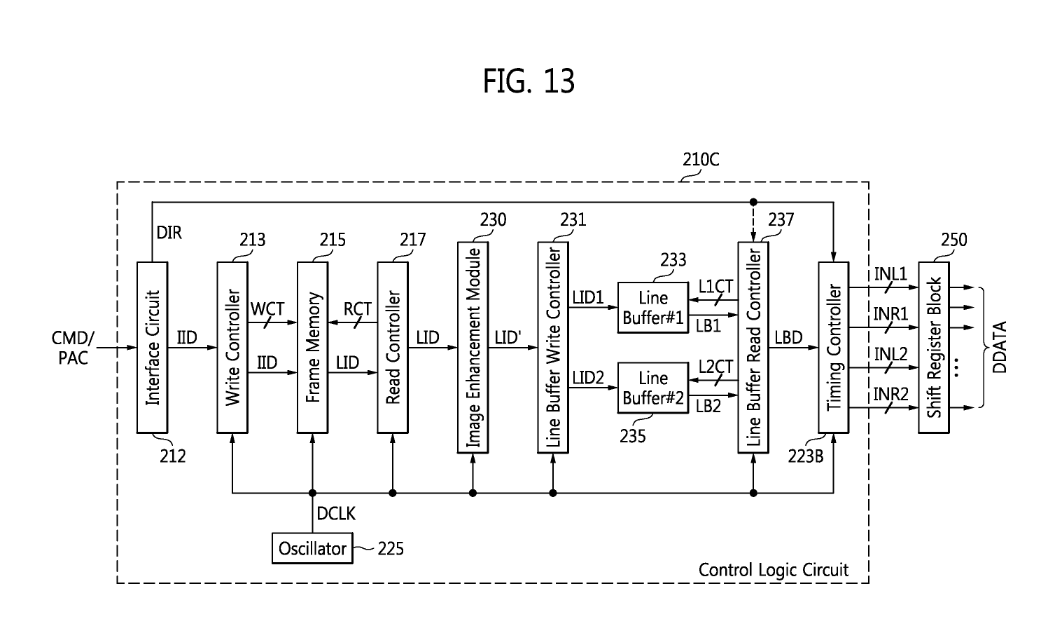

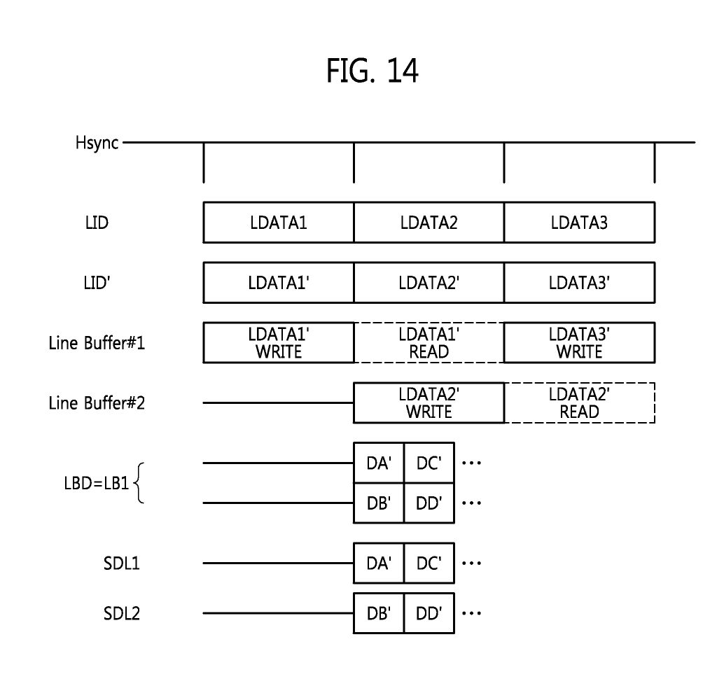

FIG. 13 is a block diagram which shows a control logic circuit of the display driver IC shown in FIG. 2, according to still another exemplary embodiment, and FIG. 14 is a timing diagram of signals which describes an operation of the control logic circuit shown in FIG. 13. For convenience of description, the operation of a control logic circuit 210C shown in FIG. 14 is described only for a case in which the control logic circuit 210C performs operations corresponding to the case 1 CASE1 of FIG. 4. However, the operations for the remaining cases 2 CASE2 to case 4 CASE 4 shown in FIG. 4 are similar.

Referring to FIG. 13, the control logic circuit 210C may include an input interface circuit 212, a write controller 213, a frame memory 215, a read controller 217, an image enhancement module 230, a line buffer write controller 231, a first line buffer 233 and a second line buffer 235, a line buffer read controller 237, a timing controller 223B, and an oscillator 225.

The interface circuit 212 may receive the data packet PAC output from the host 110, and restore (or generate) synchronization signals and image data IID from the data packet PAC using a clock signal.

As described above, the clock signal may be provided separately from the data packet PAC to be transferred from the host 110, or may be embedded in the data packet PAC. Moreover, the interface circuit 212 may receive and decode a command CMD output from the host 110, and generate the direction indication signal DIR according to a result of the decoding. In some exemplary embodiments, the direction indication signal DIR may be transferred to the line buffer read controller 237 in addition to the timing controller 223B.

In some exemplary embodiments, a decoder which can generate the direction indication signal DIR may be embodied inside or outside the interface circuit 212. The interface circuit 212 may transfer synchronization signals and image data IID to the write controller 213.

The write controller 213 may generate write control signals WCT using the display clock signal DCLK and the synchronization signals, and write the image data IID in the frame memory 215 using the write control signals WCT.

The frame memory 215 may store the image data IID according to the display clock DCLK and the write control signals WCT.

The read controller 217 may generate read control signals RCT using the display clock DCLK output from the oscillator 225.

The frame memory 215 may output line data LID in response to the read control signals RCT. The read controller 217 may read the line data LID from the frame memory 215 using the read control signals RCT. Here, the line data LID may denote respective line data LDATA1, LDATA2, LDATA3, . . . , and so forth, shown in FIGS. 4 and 14.

The image enhancement module 230 may perform an image enhancement operation on the line data LID in response to the display clock DCLK, and transfer an image-enhanced line data LID′ to the line buffer write controller 231. The line buffer write controller 231 writes the image-enhanced first line data LID1=LDATA 1′ in a first line buffer 233 in response to the display clock DCLK (operation LDATA1′ WRITE).

Referring to FIGS. 4, 5, 13, and 14, while the line buffer write controller 231 writes the image-enhanced second line data LID2=LDATA2′ in the second line buffer 235 (i.e., operation LDATA2′ WRITE in FIG. 14), the line buffer read controller 237 reads at the same time (operation LDATA1′ READ) an image-enhanced left pixel data set DA′ and an image-enhanced right pixel data set DB′, which are stored in the first line buffer 233, and transfers image-enhanced pixel data sets LBD (=DA′+DB′) to the timing controller 223B using first line buffer read control signals L1CT.

The timing controller 223B outputs the first group signals INL1 including an image-enhanced left pixel data set SDL1=DA′ to the left input terminals of the first shift register 251, and outputs the third group signals INL2 including an image-enhanced right pixel data set SDL2=DB′ to the left input terminals of the second shift register 252.

At this time, the timing controller 223B may output the first group signals INL1 and the third group signals INL2 to the shift register block 250 at the same time as shown in FIG. 9. Alternatively, the timing controller 223B may output the third group signals INL2 to the shift register block 250 within the given delay after outputting the first group signals INL1 to the shift register block 250 as shown in FIG. 10.

While the line buffer write controller 231 writes the image-enhanced second line data LID2=LDATA2′ in the second line buffer 235 (operation LDATA2′ WRITE) in response to a display clock DCLK, the line buffer read controller 237 reads at the same time using the first line buffer read control signals L1CT (operation LDATA1′ READ), an image-enhanced left pixel data set DC′ and an image-enhanced right pixel data set DD′, which are stored in the first line buffer 233, and transfers image-enhanced pixel data sets LBD (=DC′+DD′) to the timing controller 223B.

The timing controller 223B outputs the first group signals INL1 including an image-enhanced left pixel data set SDL1=DC′ to the left input terminals of the first shift register 251, and outputs the third group signals INL2 including an image-enhanced right pixel data set SDL2=DD′ to the left input terminals of the second shift transistor 252.

After the image-enhanced second line data LID2=LDATA2′ is stored in the second line buffer 235, the line buffer write controller 231 writes the image-enhanced third line data LID1=LDATA3′ in the first line buffer 233 in response to the display clock DCLK.

While the image-enhanced third line data LID1=LDATA3′ is written in the first line buffer 233 (operation LDATA3′ WRITE), the line buffer read controller 237 reads at the same time using second line buffer read control signals L2CT (operation LDATA2′ READ), an image-enhanced left pixel data set and an image-enhanced right pixel data set, which are stored in the second line buffer 235, and transfers the image-enhanced pixel data sets LBD to the timing controller 223B.

An operation of processing the image-enhanced pixel data sets stored in the second line buffer 235 by the shift register block 250 is substantially the same as an operation of processing the image-enhanced pixel data sets stored in the first line buffer 233 by the shift register block 250, describe above.

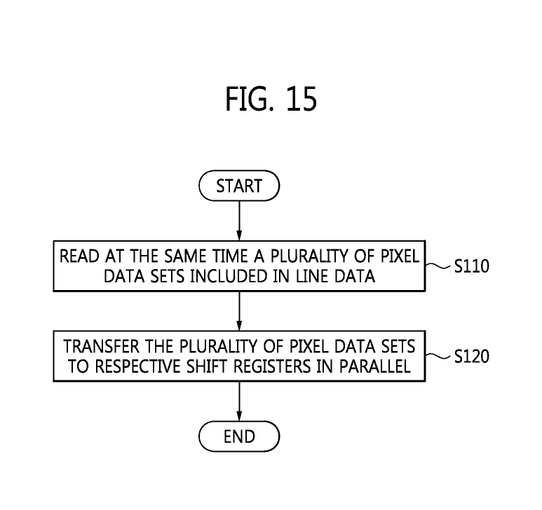

FIG. 15 is a flowchart which describes an operation of the display driver IC shown in FIG. 2, according to an exemplary embodiment. First, for convenience of description, the control logic circuit 210A is assumed to perform a case 1 CASE1 (see FIG. 4) according to a command CMD. Referring to FIGS. 1 to 10, and 15, the read controller 217 reads at the same time a plurality of pixel data sets DA and DB included in the first line data LDATA1 of the frame memory 215 (operation S110).

As shown in FIG. 9, the read controller 217 reads at the same time a plurality of pixel data sets DA and DB included in the first line data LDATA1 at a time point T1, reads at the same time a plurality of pixel data sets DC and DD included in the first line data LDATA1 at a time point T2, reads at the same time a plurality of pixel data sets DE and DF included in the first line data LDATA1 at a time point T3, and reads at the same time a plurality of pixel data sets DG and DH included in the first line data LDATA1 at a time point T4.

The first image enhancement module 219 and the second image enhancement module 221 perform image enhancement operations on the plurality of pixel data sets DA and DB, DC and DD, . . . , DE and DF, and DG and DH, respectively, in a parallel manner, and outputs a plurality of image-enhanced pixel data sets DA′ and DB′, DC′ and DD′, . . . , DE′ and DF′, and DG′ and DH′ to the timing controller 223A.

The timing controller 223A transfers the plurality of image-enhanced pixel data sets DA′ and DB′ to the shift register 251 and the shift register 253, respectively, in a parallel manner (operation S120).

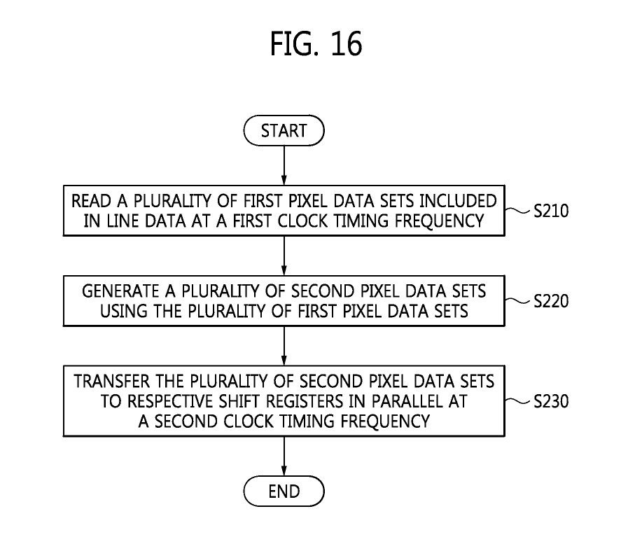

FIG. 16 is a flowchart which describes an operation of the display driver IC shown in FIG. 2, according to another exemplary embodiment. First, for convenience of description, the control logic circuit 210B is assumed to perform a case 1 CASE1 (see FIG. 4) according to a command CMD.

Referring to FIGS. 1 to 5, 11, 12, and 16, the read controller 217 reads a plurality of corresponding first pixel data sets DA and DB, DC and DD, . . . , DE and DF, or DG and DH included in the first line data LDATA1 of the frame memory 215 at a first clock timing frequency(operation S210).

The timing controller 223A generates a plurality of second pixel data sets DA′DC′, DB′DD′, . . . , DE′DG′, or DF′DH′ using the plurality of first pixel data sets DA and DB, DC and DD, . . . , DE and DF, or DG and DH according to a second clock timing frequency (operation S220). The timing controller 223A transfers the plurality of second pixel data sets DA′DC′, DB′DD′, . . . , DE′DG′, or DF′DH′ to the shift register 251 and the shift register 253, respectively, at the same time or in a parallel manner (operation S230).

In the specification, an operation which can perform the case 1 is mainly described for clarity of description; however, control logic circuits 210A, 210B, or 210C according to exemplary embodiments can perform an operation of performing the case 2, the case 3, or the case 4.

According to an exemplary embodiment, each control logic circuit 210A, 210B, or 210C may be designed in a hardware manner so as to perform only one of the case 1 to the case 4.

A method of operating a display driver IC according to an exemplary embodiment may read line data stored in a frame memory or a line buffer from each of a plurality of read start points at the same time. The method of operating a display driver IC can transfer respective data read from each of the plurality of read start points at the same time to each of two of a plurality of input ports of a shift register block in a parallel manner.

The method of operating a display driver IC can perform an image enhancement operation on respective data read from each of the plurality of read start points at the same time in a parallel manner, and transfer the respective image-enhanced data to each of two input ports among the plurality of input ports of the shift register in a parallel manner. The display driver IC can reduce the number of bits (that is, a shift data width) shifted at one time even though a resolution of a display is increased, thereby reducing a height of the display driver IC. The display driver IC can increase the number of bits (that is, a shift data width) of data shifted at one time and reduce a frequency of a shift clock.

Although a few exemplary embodiments have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A method of operating a display driver integrated circuit (IC), the method comprising:
storing first line data in a first memory; and
reading, at the same time from the first memory, a first pixel data set and a second pixel data set, which are not adjacent to each other among the first line data stored in the first memory.

2. The method of claim 1, further comprising performing a first operation which transfers first data related to the first pixel data set to one of a plurality of input ports of a first shift register and a second operation which transfers second data related to the second pixel data set to one of a plurality of input ports of a second shift register, the first operation and the second operation being performed in parallel.

3. The method of claim 2, wherein the first operation and the second operation are performed at the same time.

4. The method of claim 2, wherein the second operation is performed within one cycle of a display clock after the first operation is performed.

5. The method of claim 2, further comprising:
generating the first data by performing a first image enhancement operation on the first pixel data set using a first image enhancement module; and
generating the second data by performing a second image enhancement operation on the second pixel data set using a second image enhancement module,
wherein the first image enhancement operation and the second image enhancement operation are performed in parallel.

6. The method of claim 2, further comprising:
reading, at the same time from the first memory, a third pixel data set which is adjacent to the first pixel data set, and a fourth pixel data set which is adjacent to the second pixel data set;
generating the first data by performing a first image enhancement operation on each of the first pixel data set and the third pixel data set using a first image enhancement module; and
generating the second data by performing a second image enhancement operation on each of the second pixel data set and the fourth pixel data set using a second image enhancement module,
wherein the first image enhancement operation and the second image enhancement operation are performed in parallel.

7. The method of claim 2, wherein the one of the input ports of the first shift register and the one of the input ports of the second shift register are determined based on a command output from a host.

8. The method of claim 1, wherein the first memory is a frame memory.

9. The method of claim 1, wherein the first pixel data set and the second pixel data set are read while second line data is stored in a second memory, and the first memory is a first line buffer, and the second memory is a second line buffer that is different from the first line buffer.

10. The method of claim 9, wherein each of the first line data and the second line data is output from an identical image enhancement module.

11. A method of operating an image processing system including a display driver integrated circuit (IC) and a host, the method comprising:
storing, in a first memory by the display driver IC, first line data included in image data output from the host; and
reading, at the same time from the first memory by the display driver IC, a first pixel data set and a second pixel data set, which are not adjacent to each other among the first line data stored in the first memory.

12. The method of claim 11, further comprising:
performing a first operation which transfers first data related to the first pixel data set to one of a plurality of input ports of a first shift register and a second operation which transfers second data related to the second pixel data set to one of a plurality of input ports of a second shift register, the first operation and the second operation being performed in parallel

13. The method of claim 12, further comprising:
generating the first data by performing a first image enhancement operation on the first pixel data set using a first image enhancement module; and
generating the second data by performing a second image enhancement operation on the second pixel data set using a second image enhancement module,
wherein the first image enhancement operation and the second image enhancement operation are performed in parallel.

14. The method of claim 12, further comprising:
reading, at the same time from the first memory by the display driver IC, a third pixel data set which is adjacent to the first pixel data set, and a fourth pixel data set which is adjacent to the second pixel data set;
generating the first data by performing a first image enhancement operation on each of the first pixel data set and the third pixel data set using a first image enhancement module; and
generating the second data by performing a second image enhancement operation on each of the second pixel data set and the fourth pixel data set using a second image enhancement module,
wherein the first image enhancement operation and the second image enhancement operation are performed in parallel.

15. The method of claim 11, wherein the first pixel data set and the second pixel data set are read while second line data is stored in a second memory,
the first memory is a first line buffer, and
the second memory is a second line buffer that is different from the first line buffer.

16. A method of parallel processing data using a display driver integrated circuit (IC), the method comprising:
reading in parallel a first set of pixel data and a second set of pixel data from line data having a first portion comprising a plurality of pixel data and a second portion comprising a plurality of pixel data, the pixel data of the first set being separated from the pixel data of the second set by pixel data for at least one pixel;
performing an image enhancement operation in parallel on the first set and the second set to generate first enhanced pixel data and second enhanced pixel data respectively; and
outputting in parallel the first enhanced pixel data and the second enhanced pixel data.

17. The method of claim 16, wherein the first set comprises pixel data for at least two pixels, and the second set comprises data for at least two pixels.

18. The method of claim 16, wherein the first set and second set are read in parallel according to a direction signal which controls a first direction of reading the pixel data in the first portion of the line data, and a second direction of reading the pixel data in the second portion of the line data.

19. The method of claim 16, wherein the first set and the second set are read in parallel according to a display clock operating at a first frequency, and the first enhanced pixel data and the second enhanced pixel data are output according to a clock operating at a second frequency.

20. The method of claim 19, wherein the first frequency is different than the second frequency.
